(19) United States
(12) Patent Application Publication
(10) Pub. No.: US 2012/0153835 A1
(43) Pub. Date: Jun. 21, 2012

(54) DRIVING DEVICE OF LIGHT EMITTING DIODE AND LIGHTING APPARATUS USING THE SAME

(75) Inventors: Hung-Yen Su, New Taipei City (TW); Hao-Yung Wang, New Taipei City (TW)

(73) Assignees: Kinpo Electronics, Inc., New Taipei City (TW); Cal-Comp Electronics & Communications Company Limited, New Taipei City (TW)

(21) Appl. No.: 13/181,516

(22) Filed: Jul. 13, 2011

(30) Foreign Application Priority Data
Dec. 15, 2010 (TW) 99224352

(51) Int. Cl. H05B 37/02

(52) U.S. Cl. 315/127; 315/200 R

(57) ABSTRACT

A driving device of light emitting diode (LED) and a lighting apparatus using the same are provided. The diving device is adapted for receiving an AC power adjusted by a dimmer and a transformer unit, and includes a dimming match circuit, a voltage conversion unit, and a driver IC. The dimming match circuit receives the AC power and equalize the energy of a positive and a negative half cycles of the AC power, so as to produce a symmetrical AC power. The voltage conversion unit is coupled to the dimming match circuit, and receives and converts the symmetrical AC power into a stable DC power. The driver IC is coupled to the voltage conversion unit, and receives the stable DC power to drive and adjust the light intensity of an LED unit, and thus flicking of the light source of the LED unit can be avoided during dimming.

### CROSS-REFERENCE TO RELATED APPLICATION

This application claims the priority benefit of Taiwan application serial no. 99224352, filed on Dec. 15, 2010. The entirety of the above-mentioned patent application is hereby incorporated by reference herein and made a part of this specification.

### BACKGROUND

1. Field of the Invention

The invention relates to a lighting technique of light emitting diode (LED). Particularly, the invention relates to a driving device of LED and a light apparatus using the same.

2. Description of Related Art

In the lighting technique, a dimmer, for example, a tri-electrode AC switch (TRIAC) is usually used to adjust a brightness of a lighting apparatus. The dimmer can provide a voltage according to a conducting condition thereof to fine-tune a light emitting effect of a resistive light emitting device (for example, a halogen lamp, or a tungsten filament lamp, etc.) of the lighting apparatus. A home-used dimmer and the lighting apparatus can be separately arranged, for example, the dimmer can be disposed on the wall at a suitable position, so that a user can easily adjust the brightness of the lamp.

Moreover, along with a technological demand of carbon reduction, since light emitting diodes (LEDs) have advantages of small size, low power consumption, and good durability, etc., and since production cost thereof is reduced due to improvement of a fabrication process and yield of the LEDs, the LEDs have gradually become light sources of a new generation. The LED has a low operating voltage, and is capable of actively emitting light with a certain brightness, where the brightness can be adjusted through voltage or current, and the LED has features of impact resistance, anti-vibration, and long service life (one hundred thousand hours). Therefore, the LEDs are widely applied in various end equipments and the lighting domain, such as vehicle headlights, traffic lights, text displays, billboards, and large screen video displays, etc., and domains such as general architectural lighting and LCD backlighting, etc.

Considering the cost, a consumer generally hopes to only replace the resistive lamp by the LED lamp without changing a base and a dimmer switch of the original lighting apparatus, so as to save power while avoiding changing the whole lighting apparatus. Moreover, compared to the resistive lamps, a stable direct current (DC) power is required to drive the LED to reduce a flicking phenomenon, which has a low tolerance for power noise surges and power energy drifts. Moreover, a circuit characteristic of the LED presents a characteristic of a capacitor, so that when an AC power adjusted by the dimmer and an electronic transformer is directly used in collaboration with a LED driver to drive the LED lamp, the light source of the LED lamp may have the flickering phenomenon.

### SUMMARY OF THE INVENTION

The invention is directed to a driving device of light emitting diode (LED), and a lighting apparatus using the same, which can match energy of a positive and a negative half cycles of an AC power in collaboration of a dimmer implemented as a tri-electrode AC switch (TRIAC), so as to stably adjust a light intensity of a LED lamp to avoid a flicking phenomenon of the light source of the LED lamp.

The invention provides a driving device of light emitting diode (LED). The diving device is adapted to receive an alternating current (AC) power adjusted by a dimmer and a transformer unit. The driving device includes a dimming match circuit, a voltage conversion unit, and a driver integrated circuit (IC). The dimming match circuit receives the AC power and equalizes energy of a positive and a negative half cycles of the AC power, so as to produce a symmetrical AC power. The voltage conversion unit is coupled to the dimming match circuit, and receives and converts the symmetrical AC power into a stable direct current (DC) power. The driver IC is coupled to the voltage conversion unit, and receives the stable DC power to drive and adjust light intensity of a LED unit.

In an embodiment of the invention, the dimming match circuit has a first matching input terminal, a second matching input terminal, a first matching output terminal and a second matching output terminal. Moreover, the dimming match circuit includes a first capacitor and a first resistor to a fourth resistor. The first resistor is coupled between the first matching input terminal and the first matching output terminal, and the second resistor is coupled between the second matching input terminal and the second matching output terminal. A first end of the first capacitor is coupled to the first matching output terminal, a second end of the first capacitor is coupled to one ends of the third resistor and the fourth resistor, and other ends of the third resistor and the fourth resistor are coupled to the second matching output terminal. The first and the second matching input terminals are used for receiving the AC power, and the first and the second matching output terminals are used for outputting the symmetrical AC power.

In an embodiment of the invention, the voltage conversion unit includes a bridge rectifier coupled to the dimming match circuit. The bridge rectifier receives the symmetrical AC power, and performs a full-wave rectification to the symmetrical AC power to output the stable DC power. Moreover, the voltage conversion unit further includes a filter capacitor. A first end of the filter capacitor is coupled to the bridge rectifier for receiving the stable DC power, and a second end of the filter capacitor is coupled to a ground potential.

In an embodiment of the invention, the driver IC includes a driving unit and a buck circuit. The buck circuit receives the stable DC power, and converts the stable DC power into a bucked DC power according to a voltage specification of the driving unit. The driving unit receives the bucked DC power to drive and adjust the light intensity of the LED unit.

In an embodiment of the invention, the driver IC further includes a detecting unit coupled to the buck circuit. The detecting unit detects the bucked DC power, and forces the driving unit to stop driving the LED unit when the bucked DC power is lower than a minimum operating voltage.

In an embodiment of the invention, the driver IC is a LED driving chip complied with MR16 electrical specifications.

In an embodiment of the invention, the dimmer at least includes a tri-electrode AC switch (TRIAC).

According to another aspect, the invention provides a lighting apparatus of LED. The lighting apparatus includes a dimming control unit and a driving device. The dimming control unit generates an AC power according to a conducting condition. The driving device drives and adjusts light intensity of a LED unit according to the AC power. The driving device includes a dimming match circuit, a voltage conversion unit, and a driver IC. The dimming match circuit receives the AC power and equalizes energy of a positive and a negative half cycles of the AC power, so as to produce a symmetrical AC power. The voltage conversion unit is coupled to the dimming match circuit, and receives and converts the symmetrical AC power into a stable DC power. The driver IC is coupled to the voltage conversion unit, and receives the stable DC power to drive and adjust the light intensity of the LED unit.

In an embodiment of the invention, the dimming control unit includes a dimmer and a transformer unit. The dimmer generates a dimming power according to the conducting condition, and the transformer unit coupled to the dimmer receives the dimming power and transform it into the AC power.

According to the above descriptions, in the disclosure, to ensure the AC power of the dimming control unit can adjust the brightness of the LED unit to avoid a flickering phenomenon, the dimming matching circuit is used to adjust waveforms of the positive and the negative half cycles of the AC power to be symmetric (in other words, the dimming match circuit makes the energy of the positive and the negative half cycles of the AC power to be equal), so as to stabilize the driving power, so that the driver IC can stably control the light intensity of the LED unit, so as to avoid the flickering phenomenon of the light source of the LED unit during a dimming process.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is block diagram of a lighting apparatus of a light emitting diode (LED) according to an embodiment of the invention.

FIG. 2 is a circuit diagram of a dimming match circuit of FIG. 1.

FIG. 3 is a circuit diagram of a voltage conversion unit of FIG. 1.

FIG. 4 is a block diagram of a driver integrated circuit (IC) of FIG. 1.

### DETAILED DESCRIPTION OF DISCLOSED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

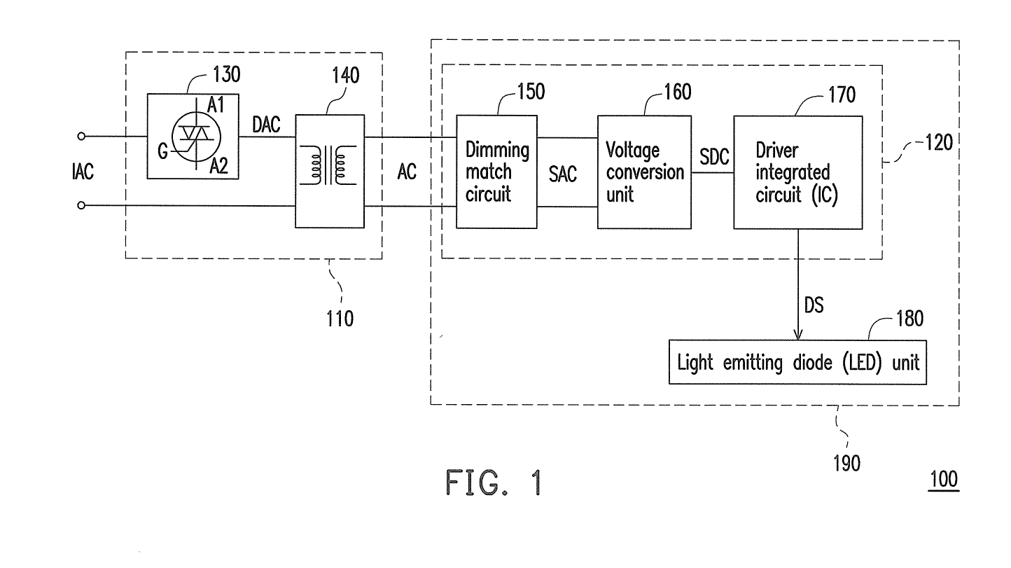

Referring to FIG. 1, FIG. 1 is block diagram of a lighting apparatus 100 of a light emitting diode (LED) according to an embodiment of the invention. As shown in FIG. 1, the lighting apparatus 100 can be regarded as a lighting equipment such as a table lamp or a pendant lamp, etc. A dimming control unit 110 can be regarded as a dimming switch of the lighting apparatus 100 and a base part of the lamp, and a driving device 120 and a LED unit 180 can be altogether regarded as a LED lamp 190 of the lighting apparatus 100.

In the present embodiment, the dimming control unit 110 includes a dimmer 130 and a transformer unit 140, and the driving device 120 includes a dimming match circuit 150, a voltage conversion unit 160 and a driver integrated circuit (IC) 170. Basically, the dimmer 130 can be implemented by a tri-electrode alternating current (AC) switch (TRIAC). Moreover, the dimmer 130 can adjust voltage waveforms of terminals A1 and A2 of the TRIAC according to a conducting condition set on a gate control terminal G of the TRIAC, so as to adjust an input power IAC (for example, a commercial power of 120V, though the invention is not limited thereto) into a dimming power DAC (for example, an effective voltage value of 120V).

Moreover, the transformer unit 140 can be implemented by an electronic transformer. In the present embodiment, the transformer unit 140 receives the dimming power DAC, and adjusts the effective voltage value of the dimming power DAC to an AC power AC (for example, 12V, though the invention is not limited thereto). Moreover, the LED unit 180 can be formed by a plurality of LEDs, and an amount and a connection method of the LEDs can be adjusted by those skilled in the art according to an actual design requirement.

A key point of the present embodiment is that in case that the base and the dimming switch part of the lighting apparatus are not changed (i.e. the dimming control unit 110 is not changed, and the dimming control unit 110 is an unchangeable part), even if an original resistive lamp (for example, a halogen lamp, or a tungsten filament lamp, etc.) is replaced by the capacitive LED lamp 190, the light source provided by the LED lamp 190 does not have a flicking phenomenon. In other words, the driving device 120 of the present embodiment is capable of driving and adjusting a light intensity of the LED unit 180 according to the AC power AC generated by the dimming control unit 110.

Further, voltage waveforms of a positive and a negative half cycles of the AC power AC are usually not matched (i.e. the energy of the input power IAC of the positive half cycle is different to the energy of the input power IAC of the negative half cycle) due to circuit mismatch of the dimming control unit 110, noise interference of the input power IAC or other reasons. Therefore, if the unmatched AC power AC is used in collaboration with a current LED driver to drive the LED lamp, the light source of the LED lamp probably has the flicking phenomenon.

Therefore, in the present embodiment, the dimming match circuit 150 of the driving device 120 receives the unmatched AC power AC, and equalizes the energy of the positive half cycle and the energy of the negative half cycle of the AC power AC, so as to generate a symmetrical AC power SAC. In this way, the voltage conversion unit 160 coupled to the dimming match circuit 150 receives and converts the symmetrical AC power SAC into a stable direct current (DC) power SDC. Moreover, the driver IC 170 is coupled to the voltage conversion unit 160 for receiving the stable DC power SDC, and generates a driving signal DS to drive and adjust the light intensity of the LED unit 180.

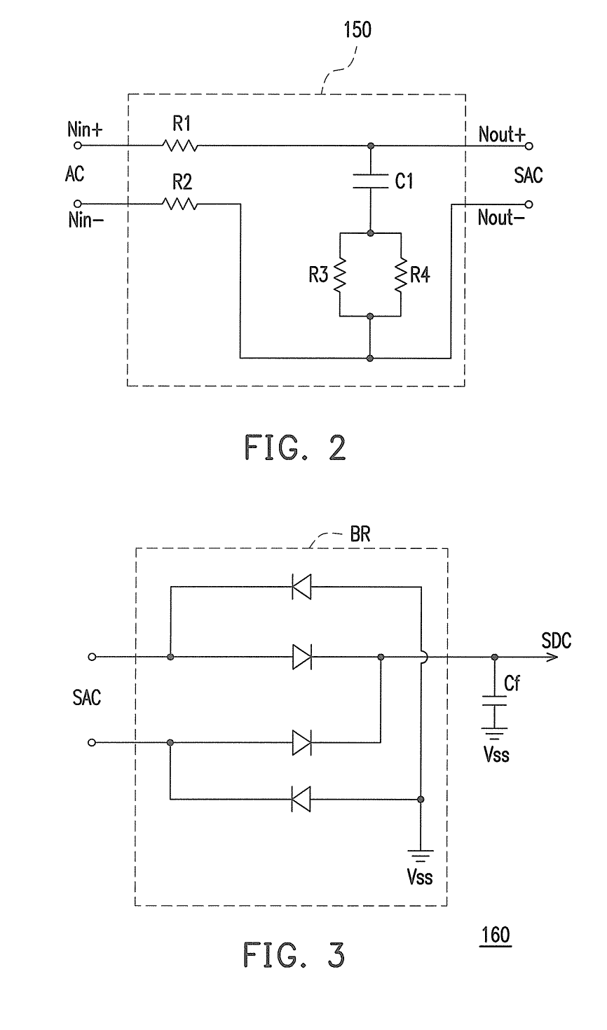

In detail, FIG. 2 is a circuit diagram of the dimming match circuit 150 of FIG. 1. Referring to FIG. 2, the dimming match circuit 150 includes a capacitor C1 and resistors R1-R4, and has a matching input terminal Nin+, a matching input terminal Nin−, a matching output terminal Nout+ and a matching output terminal Nout−. The matching input terminals Nin+ and Nin− are used for receiving the unmatched AC power AC, and the matching output terminals Nout+ and Nout− are used for outputting the relatively stable symmetrical AC power SAC.

In the present embodiment, the resistor R1 is coupled between the matching input terminal Nin+ and the matching output terminal Nout+, and the resistor R2 is coupled between the matching input terminal Nin− and the matching output terminal Nout−. Moreover, a first end of the capacitor C1 is coupled to the matching output terminal Nout+, and a second end of the capacitor C1 is coupled to one ends of the resistors R3 and R4. In addition, other ends of the resistors R3 and R4 are coupled to the matching output terminal Nout− of the dimming match circuit 150.

In this way, the resistor R1 and the capacitor C1 can be used to achieve a low-pass filter effect, so as to filter high energy pulses in the AC power AC. On the other hand, resistances of the resistors R2, R3 and R4 can be adjusted according to power energy states of the positive and the negative half cycles of the AC power AC (for example, voltage variation states of the positive and the negative half cycles, though the invention is not limited thereto), so as to match the AC power AC and stabilize a waveform thereof, so that the energy of the positive half cycle can be equal to the energy of the negative half cycle of the AC power AC, so as to generate the symmetrical AC power SAC. In other words, the dimming match circuit 150 may equalize the voltage waveform of the positive half cycle and the voltage waveform of the negative half cycle of the AC power AC, so as to generate the symmetrical AC power SAC.

On the other hand, FIG. 3 is a circuit diagram of the voltage conversion unit 160 of FIG. 1. Referring to FIG. 3, in the present embodiment, the voltage conversion unit 160 may include a bridge rectifier BR and a filter capacitor Cf. The bridge rectifier BR is coupled between the dimming match circuit 150 and the driver IC 170 for receiving the symmetrical AC power SAC and performing a full-wave rectification thereto, so as to output the stable DC power SDC. A first end of the filter capacitor Cf is coupled to the bridge rectifier BR for receiving the stable DC power SDC, and a second end of the filter capacitor Cf is coupled to a ground potential Vss, so as to filter the stable DC power SDC.

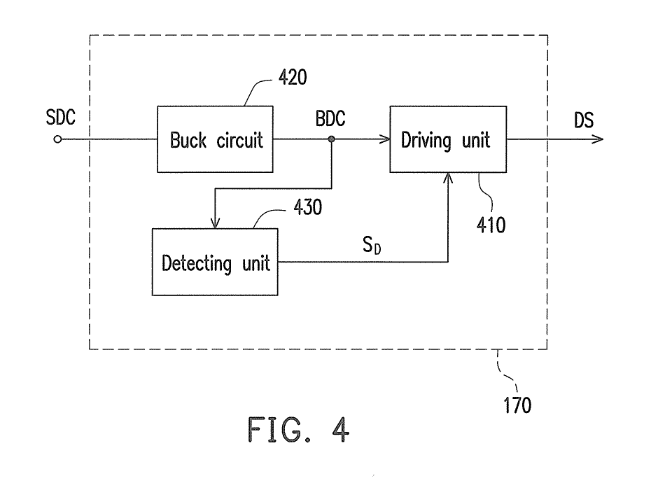

Moreover, FIG. 4 is a block diagram of the driver IC 170 of FIG. 1. Referring to FIG. 4, in the present embodiment, the driver IC 170 can be a LED driving chip complied with the MR16 electrical specifications. Moreover, the driver IC 170 includes a driving unit 410, a buck circuit 420 and a detecting unit 430. The buck circuit 420 receives the stable DC power SDC, and converts the stable DC power SDC according to a voltage specification of the driving unit 410, so as to generate a bucked DC power BDC to serve as an operating voltage required by the driving unit 410, and since a design principle and an operation method of the buck circuit are known by those skilled in the art, detailed descriptions thereof are not repeated. The driving unit 410 receives the bucked DC power BDC, and generates the driving signal DS to drive and adjust the light intensity of the LED unit 180.

The detecting unit 430 is coupled to the buck circuit 420 and the driving unit 410 for detecting the bucked DC power BDC, and detects whether the bucked DC power BDC is lower than a minimum operating voltage of the driving unit 410 according to the power specification of the driving unit 410. Once the detecting unit 430 detects that the bucked DC power BDC is lower than the minimum operating voltage of the driving unit 410, the detecting unit 430 generates a control signal S_{D} to force the driving unit 170 to stop driving the LED unit 180.

For example, since the driver IC 170 of the present embodiment is complied with the MR16 electrical specifications, the operating voltage of the driver IC 170 is between 6V and 30V. In other words, when the bucked DC power BDC is greater than 6V and smaller than 30V, the driving unit 410 can successfully drive the LED unit 180 in response to the bucked DC power BDC. Comparatively, when the detecting unit 430 detects that the bucked DC power BDC is smaller than the minimum operating voltage of the driver IC 170 (i.e. the minimum operating voltage 6V of the MR16 electrical specifications), the detecting unit 430 sends the control signal S_{D} to the driving unit 170 to force the driving 170 to stop driving the LED unit 180.

In summary, in the disclosure, to ensure the AC power of the dimming control unit can adjust the brightness of the LED unit to avoid a flickering phenomenon, the dimming matching circuit is used to adjust waveforms of the positive and the negative half cycles of the AC power to be symmetric (in other words, the dimming match circuit makes the energy of the positive and the negative half cycles of the AC power to be equal), so as to stabilize the driving power, so that the driver IC can stably control the light intensity of the LED unit, so as to avoid the flickering phenomenon of the light source of the LED unit during a dimming process.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A driving device of light emitting diode (LED), adapted to receive an alternating current (AC) power adjusted by a dimmer and a transformer unit, and the driving device comprising:
a dimming match circuit, for receiving the AC power and equalizing energy of a positive half cycle and energy of a negative half cycle of the AC power, so as to produce a symmetrical AC power;
a voltage conversion unit, coupled to the dimming match circuit, for receiving and converting the symmetrical AC power into a stable direct current (DC) power; and
a driver integrated circuit (IC), coupled to the voltage conversion unit, for receiving the stable DC power to drive and adjust a light intensity of a LED unit,
wherein the dimming match circuit has a first matching input terminal, a second matching input terminal, a first matching output terminal and a second matching output terminal, and the dimming match circuit comprises:
a first resistor, coupled between the first matching input terminal and the first matching output terminal;
a second resistor, coupled between the second matching input terminal and the second matching output terminal;
a first capacitor, having a first end coupled to the first matching output terminal;
a third resistor, coupled between a second end of the first capacitor and the second matching output terminal; and
a fourth resistor, coupled between the second end of the first capacitor and the second matching output terminal,
wherein the first and the second matching input terminals are used for receiving the AC power, and the first and the second matching output terminals are used for outputting the symmetrical AC power.

2. The driving device of LED as claimed in claim 1, wherein the voltage conversion unit comprises:
a bridge rectifier, coupled to the dimming match circuit, for receiving the symmetrical AC power, and performing a full-wave rectification to the symmetrical AC power to output the stable DC power.

3. The driving device of LED as claimed in claim 2, wherein the voltage conversion unit further comprises:
a filter capacitor, having a first end coupled to the bridge rectifier for receiving the stable DC power, and a second end coupled to a ground potential.

4. The driving device of LED as claimed in claim 1, wherein the driver IC comprises:
a driving unit, for receiving a bucked DC power to drive and adjust the light intensity of the LED unit; and
a buck circuit, for receiving the stable DC power, and converting the stable DC power into the bucked DC power according to a voltage specification of the driving unit.

5. The driving device of LED as claimed in claim 4, wherein the driver IC further comprises:
a detecting unit, coupled to the buck circuit, for detecting the bucked DC power, and forcing the driving unit to stop driving the LED unit when the bucked DC power is lower than a minimum operating voltage.

6. The driving device of LED as claimed in claim 1, wherein the driver IC is a LED driving chip complied with MR16 electrical specifications.

7. The driving device of LED as claimed in claim 1, wherein the dimmer at least comprises a tri-electrode AC switch (TRIAC).

8. A lighting apparatus of light emitting diode (LED), comprising:
a dimming control unit, for generating an alternating current (AC) power according to a conducting condition; and
a driving device, comprising:
a dimming match circuit, for receiving the AC power and equalizing energy of a positive half cycle and energy of a negative half cycle of the AC power, so as to produce a symmetrical AC power;
a voltage conversion unit, coupled to the dimming match circuit, for receiving and converting the symmetrical AC power into a stable DC power; and
a driver IC, coupled to the voltage conversion unit, for receiving the stable DC power to drive and adjust a light intensity of the LED unit,
wherein the dimming control unit comprises:
a dimmer, for generating a dimming power according to the conducting condition; and
a transformer unit, coupled to the dimmer, for receiving and transforming the dimming power into the AC power.

9. The lighting apparatus of LED as claimed in claim 8, wherein the dimming match circuit has a first matching input terminal, a second matching input terminal, a first matching output terminal and a second matching output terminal, and the dimming match circuit comprises:
a first resistor, coupled between the first matching input terminal and the first matching output terminal;
a second resistor, coupled between the second matching input terminal and the second matching output terminal;
a first capacitor, having a first end coupled to the first matching output terminal;
a third resistor, coupled between a second end of the first capacitor and the second matching output terminal; and
a fourth resistor, coupled between the second end of the first capacitor and the second matching output terminal,
wherein the first and the second matching input terminals are used for receiving the AC power, and the first and the second matching output terminals are used for outputting the symmetrical AC power.

10. The lighting apparatus of LED as claimed in claim 8, wherein the voltage conversion unit comprises:
a bridge rectifier, coupled to the dimming match circuit, for receiving the symmetrical AC power, and performing a full-wave rectification to the symmetrical AC power to output the stable DC power.

11. The lighting apparatus of LED as claimed in claim 10, wherein the voltage conversion unit further comprises:
a filter capacitor, having a first end coupled to the bridge rectifier for receiving the stable DC power, and a second end coupled to a ground potential.

12. The lighting apparatus of LED as claimed in claim 8, wherein the driver IC comprises:
a driving unit, for receiving a bucked DC power to drive and adjust the light intensity of the LED unit; and
a buck circuit, for receiving the stable DC power, and converting the stable DC power into the bucked DC power according to a voltage specification of the driving unit.

13. The lighting apparatus of LED as claimed in claim 12, wherein the driver IC further comprises:
a detecting unit, coupled to the buck circuit, for detecting the bucked DC power, and forcing the driving unit to stop driving the LED unit when the bucked DC power is lower than a minimum operating voltage.

14. The lighting apparatus of LED as claimed in claim 8, wherein the dimmer at least comprises a tri-electrode AC switch (TRIAC).

15. The lighting apparatus of LED as claimed in claim 8, wherein the driver IC is a LED driving chip complied with MR16 electrical specifications.
